(19) United States
(12) Patent Application Publication
(10) Pub. No.: US 2009/0129486 A1
(43) Pub. Date: May 21, 2009

(54) SYSTEMS AND METHODS FOR PROVIDING SECURITY COMMUNICATION PROCESESS IN A SECURITY SYSTEM

(75) Inventors: Ted NESSE, Stillwater, MN (US); Jim STEVENS, Mahtomedi, MN (US)

Correspondence Address: HAMRE, SCHUMANN, MUELLER & LARSON, P.C., P.O. BOX 2902, MINNEAPOLIS, MN, 55402-0902, US

(73) Assignee: Sequel Technologies, LLC., Golden Valley, MN (US)

(21) Appl. No.: 11/940,630

(22) Filed: Nov. 15, 2007

(51) Int. Cl. H04L 27/00

(52) U.S. Cl. 375/259

(57) ABSTRACT

A system that provides security communication processes in a security system is provided. The system has a digital signal processor (“DSP”), a memory portion and a coder/decoder (“CODEC”). The DSP implements a plurality of different communication processes. The memory portion has a plurality of communication algorithms that implement a corresponding communication process within the DSP. The CODEC is connected to the DSP to convert analog signals into digital signals prior to being sent to the DSP and to convert digital signals sent from the DSP into analog signals. The DSP is connected to the memory portion to enable retrieval of the at least one communication algorithm for use in implementing the corresponding communication process.

### FIELD

This disclosure relates generally to the field of security systems. More particularly, the disclosure relates to systems and methods for providing security communication processes in a security system.

### BACKGROUND

Providing different security communication processes in a security system is known. These different communication processes include: low speed modem communication and specialized modulation and tone detection for an event transmission; high speed modem operation for remote configuration and control; dual tone multi frequency (DTMF) reception for remote control operations; voice transmission to remote phone users for status and control operations; voice playback to local users for status announcements; and two-way speakerphone operation.

Typically, these communication processes are implemented in a security system using specialized application specific integrated circuits (ASIC) components. However, separate hardware design for each of these communication processes becomes both costly and complex. Also, ASIC manufacturers often discontinue production of specialized parts for which there is no direct replacement. This can lead to expensive redesign effort with possibly no improvement to product performance. Also, an expensive redesign effort to the ASIC component is required if new features are to be added to the communication process.

For the reasons stated above, and for other reasons stated below that will become apparent to those skilled in the art upon reading and understanding the present specification, there is a need in the art for improved systems and methods for providing security communication processes in a security system.

### SUMMARY

This disclosure relates to improved systems and methods for providing security communication processes in a security system. This system and method would allow communication processes to be implemented into the security system easily and at low cost. In particular, a plurality of security communication processes used in a security system are implemented within a single digital signal processor (“DSP”). The communication processes are stored in a rewritable memory portion so that the DSP can implement new communication processes or update existing communication processes without costly and complex redesign efforts.

In one embodiment, a system that provides security communication processes in a security system is provided. The system has a digital signal processor (“DSP”), a memory portion and a coder/decoder (“CODEC”). The DSP implements a plurality of different communication processes. The memory portion has a plurality of communication algorithms, each of which implements one or more communication process within the DSP. The CODEC is connected to the DSP to convert analog signals into digital signals prior to being sent to the DSP and to convert digital signals sent from the DSP into analog signals. The DSP is connected to the memory portion to enable retrieval of the at least one communication algorithm for use in implementing the corresponding communication process.

In another embodiment, a method of implementing a security communication process within a security system is provided. The method comprises providing a security system comprising a system controller, a memory portion, a CODEC and a DSP within a main controller module and accessing at least one communication algorithm from the memory portion using the digital signal processor. The method also comprises implementing the security communication process with the digital signal processor using the at least one communication algorithm.

### DESCRIPTION OF THE DRAWINGS

FIG. 1 is a block diagram of a security system according to one embodiment.

FIG. 2 is a block diagram of a main controller module according to one embodiment.

FIG. 3A provides a block diagram of an event communication process according to one embodiment.

FIG. 3B provides a block diagram of a voice playback process according to one embodiment.

FIG. 3C provides a block diagram of a telephone control process according to one embodiment.

FIG. 3D provides a block diagram of a two-way speakerphone process according to one embodiment.

FIG. 3E provides a block diagram of a remote programming process according to one embodiment.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice what is claimed, and it is to be understood that other embodiments may be utilized and that logical, mechanical and electrical changes may be made without departing from the spirit and scope of the claims. The following detailed description is, therefore, not to be taken in a limiting sense.

Embodiments presented herein involve systems and methods for providing security communication processes in a security system. Advantageously, these embodiments provide communication processes that can be implemented into the security system easily and at a low cost. Moreover, these embodiments allow improvements to the communication processes to be implemented without costly and complex redesign efforts.

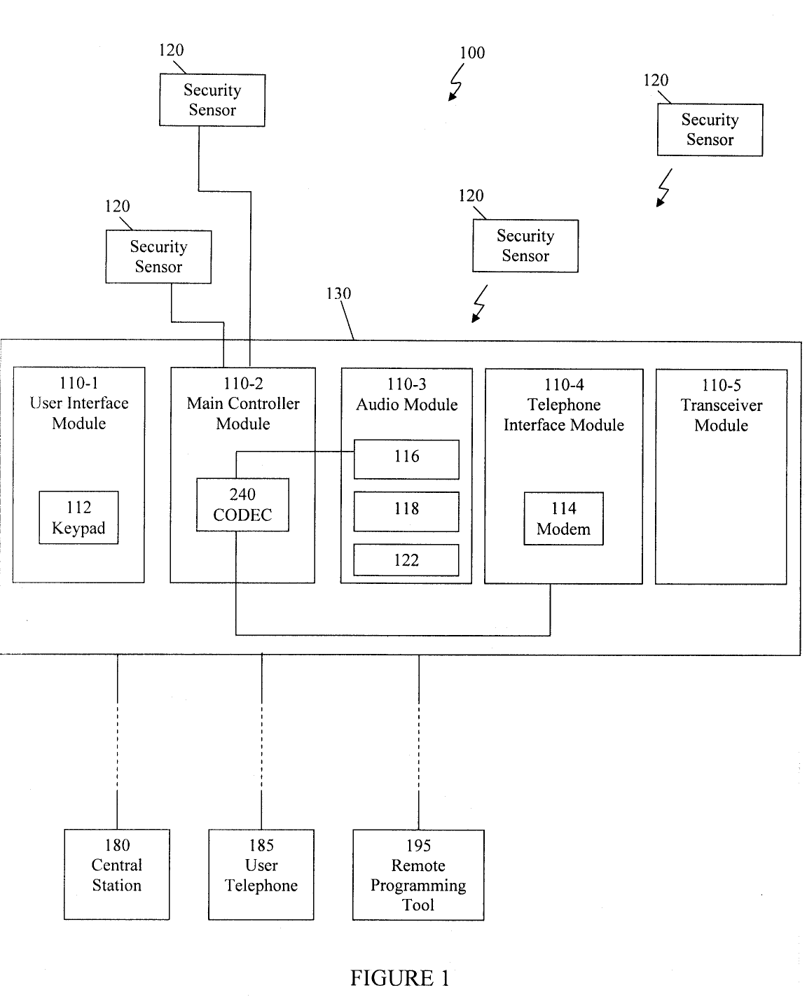

FIG. 1 is a block diagram of a security system 100 according to one embodiment. Security system 100 comprises a plurality of hardware device module modules and a plurality of security sensor devices 120. Examples of hardware device modules include, but are not limited to, a user interface module 110-1 with a keypad 112, a main controller module 110-2, an audio module 110-3 with an audio amplifier 116, a speaker 118 and a microphone 122, a telephone interface module 110-4 with a modem 114 and a transceiver module 110-5.

Examples of security sensor devices 120 include, but are not limited to: a door/window sensor that detects when a portal is opened; a motion detector that detects movement within an space; a smoke detector that detects smoke within a set area; a heat detector that detects excessive heat within a set area; a low temperature detector that detects a potentially hazardous temperature within a set area; a glassbreak detector which detects a breakage of glass. The security sensor device 120 can also be a device initiated by a user, for example a key fob that allows the user to initiate a communication message by pressing a button on the keyfob.

As shown in FIG. 1, the hardware device modules are all enclosed within a housing 130. A central station 180, a user telephone 185 and a remote programming tool 195, each typically located outside of the premises being secured, can also be indirectly coupled to the security system 100.

In one embodiment, the security system 100 generally functions as follows. The security sensor devices 120 are used to transmit communication messages that contain status signals of various portions of the premises being monitored by the security system 100. As shown in FIG. 1, some security sensor devices 120 are coupled to the main controller module 110-2 via a wire connection allowing communication messages sent from the security sensor devices 120 to be received by and stored in the main controller 110-2. Also, some security sensor devices 120 are coupled to the main controller module 110-2 via a wireless connection such that the transceiver module 110-5 receives wireless communications messages sent from the security sensor devices 120 and stores them in the main controller module 110-2. In some embodiments, the security sensor devices 120 are all coupled to the main controller module 110-2 via a wire connection and in some embodiments the security sensor devices 120 are all coupled to the main controller module 110-2 via a wireless connection. The main controller module 110-2 parses the status signal contained within the communication message, determines the appropriate action to be taken by the security system 100 and prepares and sends instruction signals to the appropriate hardware device modules. Depending on the instruction signals sent by the main controller module 110-2, the various hardware device modules then perform the appropriate actions required by the instruction signals. For example, in the case of an emergency, an instruction signal can be sent to the telephone interface module 110-4 that instructs the telephone interface module 110-4 to transmit an event communication notifying the central station 180 of an emergency and the need for police, fire or ambulance assistance.

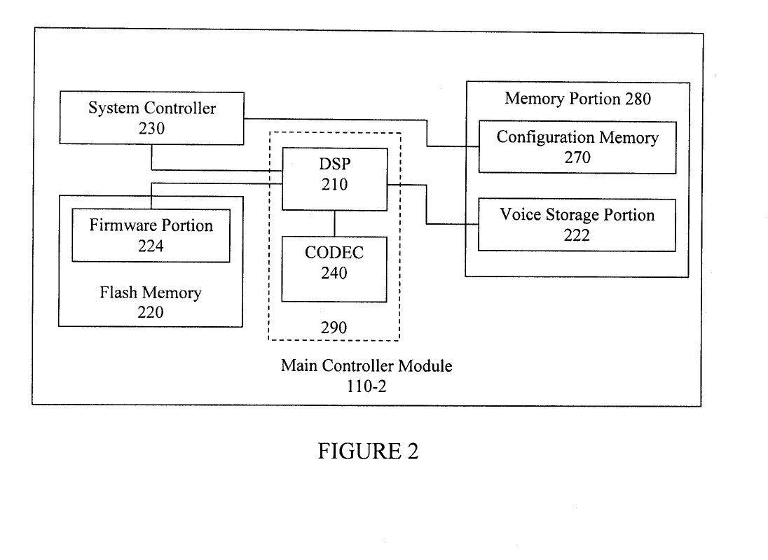

FIG. 2 is a block diagram of a main controller module 110-2 according to one embodiment. The main controller module 110-2 includes a DSP 210 coupled to a flash memory 220 stored within a system controller 230, a voice storage portion 222 included within a memory portion 280 and a CODEC 240. The CODEC 240 is coupled to the audio amplifier 116 of the audio module 110-3 and to the telephone interface module 110-4 (shown in FIG. 1). In some embodiments, the CODEC 240 and the DSP 210 are integrated into a single device 290.

The flash memory 220 is a field-rewritable memory storage device that includes a firmware portion 224. The firmware portion 224 can be implemented with various firmware functions to be accessed and used by the DSP 210. These functions include, but are not limited to, event communication functionality, voice playback functionality, phone control functionality, two way voice operation functionality and remote programming functionality. Moreover, since the flash memory 220 is a field rewritable memory storage device, new firmware functions or configuration updates to existing firmware functions can be implemented without any hardware changes.

The system controller 230, among other functions, processes communication messages sent from the security sensors 120 and generates instruction signals for the hardware device modules based on the communication message received. The system controller 230 is coupled to the DSP 210 and the configuration memory 270 included within the memory portion 280 that stores configuration settings for the hardware device modules and the security sensors 120.

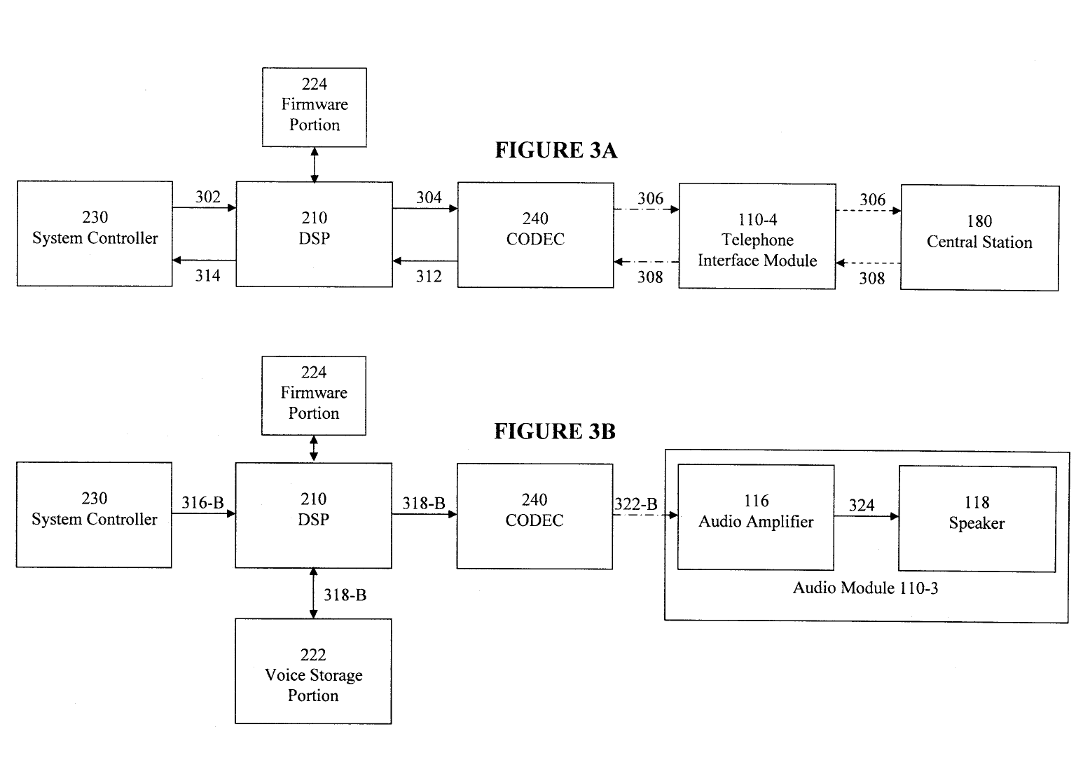

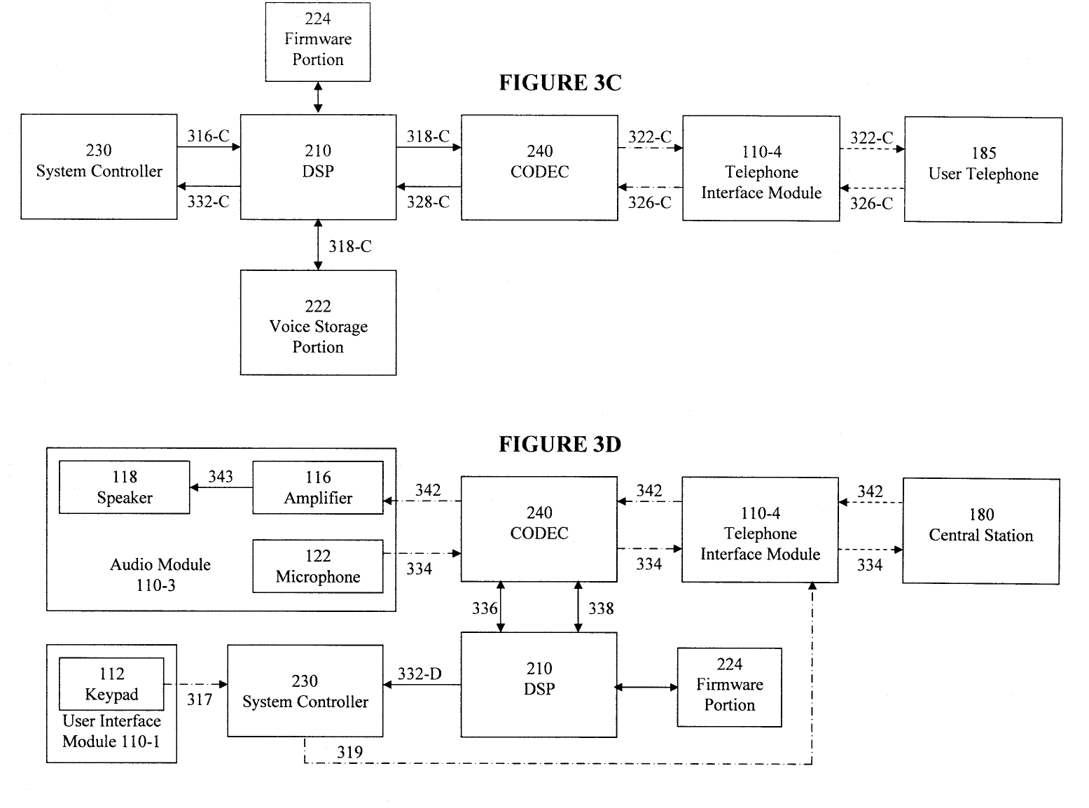

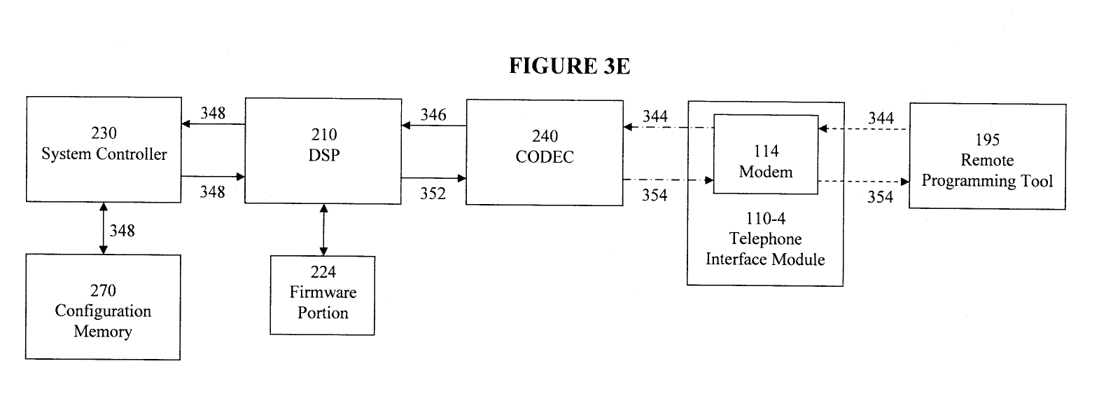

FIGS. 3A-3E are block diagrams of various communication processes performed by the DSP 210 in the security system 100 according to one embodiment. One communication function of the security system 100 is to provide event communication to the central station 180 via the telephone interface module 110-4. FIG. 3A provides a block diagram of an event communication process according to one embodiment. If the event communication sent to the central station 180 is an emergency, the central station 180 can notify the proper emergency response teams, such as the local police, fire department or hospital.

As described with respect to FIGS. 1 and 2, when the main controller module 110-2 receives a communication message from one or more of the security sensor devices 120, the system controller 230 processes the communication message and prepares and sends one or more instruction signals to the appropriate hardware device modules. As shown in FIG. 3A, when the system controller 230 determines that a transmission is required to be sent to the central station 180, the system controller 230 prepares and sends an event instruction 302 to the DSP 210. The DSP 210 accesses the firmware portion 224 for event communication algorithms, including a data modulation algorithm and a tone decoding algorithm, to generate an event communication 304 based on the event instruction 302. The event communication 304 is sent to the CODEC 240 which encodes the event communication 304 into an encoded event communication 306. The CODEC 240 then sends the encoded event communication 306 to the telephone interface module 110-4. The telephone interface module 110-4 receives the encoded event communication 306 and sends the encoded event communication 306 via a telephone line of the premises being secured, to the central station 180. The central station 180 receives the encoded event communication 306 and responds to the encoded event communication 306 by creating an encoded event confirmation 308 to confirm to the security system 100 that the central station 180 received the encoded event communication 306.

The central station 180 sends the encoded event confirmation 308 to the telephone interface module 110-4 via the same telephone line connection. The telephone interface module 110-4 receives the encoded event confirmation 308 from the central station 180 and sends the encoded event confirmation 308 to the CODEC 240. The CODEC 240 decodes the encoded event confirmation and sends a decoded event confirmation 312 to the DSP 210. The DSP 210 uses the event notification algorithms to demodulate the decoded event confirmation 312 and to send an event confirmation 314 to the system controller 230.

Another communication function of the security system 100 is to provide a voice playback process using the audio module 110-3 to people located on the premises being secured. FIG. 3B provides a block diagram of a voice playback process according to one embodiment. For example, the security system 100 can notify people located on the premises being secured that a smoke detector has detected smoke on a portion of the premises.

When the system controller 230 determines that a voice playback is required, the system controller 230 prepares and sends a voice playback instruction 316-B to the DSP 210. The DSP 210 accesses the firmware portion 224 for a voice playback algorithm to retrieve a digital voice playback recording 318-B from the voice storage portion 222 from the memory portion 280. The digital voice playback recording 318-B is sent to the CODEC 240 where it is converted to an analog voice playback recording 322-B. The CODEC 240 then sends the analog voice playback recording 322-B to the audio amplifier 116 of the audio module 110-3. The audio amplifier 116 amplifies the analog voice playback recording 322-B and broadcasts an amplified voice playback recording 324 via the speaker 118, where it can be heard by persons on the premises being secured.

Also, another communication function of the security system 100 is to provide users control of the security system 100 over the user telephone 185. FIG. 3C provides a block diagram of a telephone control process according to one embodiment. For example, users can change settings of the security system 100, including activating or deactivating the security system 100, via the user telephone 185 that may or may not be on the premises being secured by the security system 100. The user connects to the security system 100 through the user telephone 185 via the telephone interface module 110-4. When connected through a telephone line, the telephone control process includes a voice playback function that allows the security system 100 to provide sound recordings to the user, similar to the voice playback process discussed above with FIG. 3B, and a DTMF tone detection function that allows the user to send information to the system controller 230. The DTMF tone detection process allows users to send data to the security system 100 by pressing keys on the keypad of the user telephone 185.

For the voice playback function, the system controller 230 prepares and sends a voice playback instruction 316-C to the DSP 210. The DSP 210 accesses the firmware portion 224 for phone control algorithms that includes a voice playback algorithm to retrieve a digital voice playback recording 318-C from the voice storage portion 222 from the memory portion 280. The digital voice playback recording 318-C is sent to the CODEC 240 where it is converted to an analog voice playback signal 322-C. The CODEC 240 then sends the analog voice playback signal 322-C to the telephone interface module 110-4. The telephone interface module 110-4 sends the analog voice playback signal 322-C to the user telephone 185, where it can be heard by the user.

Examples of voice playback recordings include, for example, informing the user of possible system settings available for setting the security system 100, verifying options selected by the user using the keypad of the user telephone 185 and notifying the user of the status of the security system 100.

For the DTMF tone detection function, each key press by a user on the keypad of the user telephone 185 creates an analog tone message 326-C that is received by the telephone interface module 110-4 over a telephone line. The analog tone message 326-C is sent by the telephone interface module 110-4 to the CODEC 240. The CODEC 240 receives the analog tone message 326-C and converts said analog tone message 326-C into a digital tone message 328-C. The CODEC sends the digital tone message 328-C to the DSP 210. The DSP 210 uses the phone control algorithms that include the DTMF tone detection algorithm, to process the digital tone message 328-C and create an instruction signal 332-C. The DSP 210 then sends the instruction signal 332-C to the system controller 230. The system controller 230 receives the instruction signal 332-C, and determines an action to be performed based on the information in the instruction signal 332-C.

Yet another communication function of the security system 100 is to provide two-way speakerphone communication between the user and the central station 180. The DSP 210 accesses the firmware portion 224 for two-way speakerphone operation algorithms that provides the security system 100 with speakerphone capability between the user and the central station over a telephone line using the audio module 110-3 and the telephone interface module 110-4. FIG. 3D provides a block diagram of a two-way communication process according to one embodiment. For example, users can notify the central station 180 of an emergency or provide the central station 180 information relating to the status of the security system 100 through speech using the microphone 122 of the audio module 110-3. Also, the central station 180 can notify the user that emergency assistance is on its way to the premises being secured or query the user about a recent alarm by speaking with the user. Additionally, the central station can control the operation of the speakerphone function using the DTMF tone detection function described above and in FIG. 3C.

In further embodiments, other connection types between the security system 100 and the central station 180 can be used, including, for example, a cable connection, an Ethernet connection and a wireless connection. In these embodiments, the central station communication signal 342 is a digital signal and is sent from the central station 180 to the DSP 210, bypassing the telephone interface module 110-4 and the CODEC 240.

In one embodiment, the two-way communication of the security system 100 is activated when an alarm event notification is transmitted to the central station 180, or when the central station 180 calls the premises being secured after receiving an alarm event notification from the premises. For example, in some embodiments the user can activate the two-way communication of the security system 100 by pressing an alarm on the keypad 112. In some embodiments, the alarm can include a police panic alarm, a fire panic alarm and an ambulance panic alarm. The system controller 230 processes the alarm event notification 317 and creates an activation instruction 319. The activation instruction 319 is sent to the telephone interface module 110-4 to create a connection with the central station 180. Once connected, the user can communicate to the central station 180 with speech using the microphone 122 of the audio module 110-3 as well has listen to the operator at the central station using the speaker 118 of the audio module 110-3.

In some embodiments, the security system 100 uses a voice operated exchange (“VOX”) method for two-way communication in which the DSP 210 automatically switches the security system 100 between a talk and listen mode by analyzing the signals received from the microphone 122 and the central station 180 almost simultaneously. In these embodiments, the microphone 122 collects and converts picked up sound waves into an analog microphone signal 334 and the analog microphone signal 334 is sent to the CODEC 240. The CODEC 240 converts the analog microphone signal 334 into a digital microphone signal 336 and sends the digital user microphone signal 336 to the DSP 210.

At the same time, the telephone interface module 110-4 receives an analog central station communication signal 342 from the central station 180 via a telephone line and sends the analog central station communication signal 342 to the CODEC 240. The CODEC 240 receives and converts the analog central station communication signal 342 into the digital central station communication signal 338. The CODEC 240 then sends the digital central station communication signal 338 to the DSP 210.

The DSP 210 uses the two-way speakerphone algorithms that include a DTMF tone detection algorithm from the firmware portion 224 to determine whether the digital central station communication signal 338 is a DTMF command. If the digital central station communication signal 338 is a DTMF command, the DSP 210 creates an instruction signal 332-D and sends said instruction signal 332-D to the system controller 230. The system controller 230 receives the instruction signal 332-D, and determines an action to be performed based on the information stored in the instruction signal 332-D. In some embodiments, the central station 180 is able to control the two-way communication process with DTMF commands for listen, high gain listen, talk, VOX mode, extend mode to keep the two-way communication process active, and disconnect. If the DSP 210 determines that the digital central communication signal 338 is not a DTMF command, then the DSP 210 uses a VOX algorithm to provide two-way communication.

The VOX algorithm allows the DSP 210 to analyze the digital microphone signal 336 and the digital central station communication signal 338 almost simultaneously to determine whether to switch the two-way speakerphone process into a talk mode or a listen mode. The DSP 210 switches the two-way speakerphone process into a talk mode when it detects that the sound level of the digital microphone signal 336 exceeds a minimum sound level threshold, regardless of the sound level of the digital central station communication signal 338. The DSP 210 switches the two-way speakerphone process into a listen mode when the digital central station communication signal 338 exceeds a minimum sound level threshold and the digital microphone signal 336 is below the minimum sound level threshold. Thus, if both a user and the central station 180 are attempting to communicate at the same time, the user's communication will be sent to the central station 180 while the central station's 180 communication is removed. It would be obvious that in other embodiments, that the DSP 210 switches the two-way speakerphone process into a listen mode when the digital central station communication signal 338 exceeds a minimum sound level threshold, regardless of the sound level of the digital microphone signal 336.

When the DSP 210 switches the two-way speakerphone process into a talk mode, the digital microphone signal 336 is sent back to the CODEC 240 and the digital central station communication signal 338 is removed. The CODEC 240 converts the digital microphone signal 336 back into the analog microphone signal 334 and sends the analog microphone signal 334 to the telephone interface module 110-4. The telephone interface module 110-4 receives the analog microphone signal 334 and sends the analog microphone signal 334 via a telephone line to the central station 180.

When the DSP 210 switches the security system 100 into a listen mode, the digital central station communication signal 338 is sent back to the CODEC 240 and the digital microphone signal 336 is removed. The CODEC 240 converts the digital central station communication signal 338 back into the analog central station communication signal 342 and sends the analog central station communication signal 342 to the audio amplifier 116 of the audio module 110-3. The audio amplifier 116 receives the analog central station communication signal 342 and amplifies the analog central station communication signal 342. The audio amplifier then sends the amplified central station communication signal 343 to the speaker 118 which broadcasts the amplified central station communication signal 343 to be heard by the user.

In other embodiments, the security system 100 uses a dynamic echo cancellation method for two-way communication. In these embodiments, the microphone 122 collects and converts picked up sound waves into the analog microphone signal 334 and the analog microphone signal 334 is sent to the CODEC 240. The CODEC 240 converts the analog microphone signal 334 into the digital microphone signal 336 and sends the digital user microphone signal 336 to the DSP 210. The DSP 210 receives the digital microphone signal 336 and uses the two-way speakerphone algorithms from the firmware portion 224 to determine whether the digital microphone signal 336 is feedback from a previously received digital central station communication signal 338 sent from the central station 180 and broadcasted over the speaker 118 of the audio module 110-3. If the digital microphone signal 336 is determined to be feedback from the digital central station communication signal 338, the digital microphone signal 336 is removed. If the digital microphone signal 336 is not determined to be feedback from the digital central station communication signal 338, the digital microphone signal 336 is sent back to the CODEC 240. The CODEC 240 converts the digital microphone signal 336 back into the analog microphone signal 334 and sends the analog microphone signal 334 to the telephone interface module 110-4. The telephone interface module 110-4 receives the analog microphone signal 334 via a telephone line to the central station 180. When the central station 180 communicates to the user or the security system 100, the analog central station communication signal 342 is sent via a telephone line to the telephone interface module 110-4 of the security system 100. The telephone interface module 110-4 receives the analog central station communication signal 342 and sends the analog central station communication signal 342 to the CODEC 240. The CODEC 240 receives and converts the analog central station communication signal 342 into the digital central station communication signal 338. The CODEC 240 then sends the digital central station communication signal 338 to the DSP 210. The DSP 210 uses the two-way speakerphone algorithms that include a DTMF tone detection algorithm from the firmware portion 224 to determine whether the digital central station communication signal 338 is a DTMF command. If the digital central station communication signal 338 is a DTMF command, the DSP 210 creates an instruction signal 332-D and sends said instruction signal 332-D to the system controller 230. The system controller 230 receives the instruction signal 332-D, and determines an action to be performed based on the information stored in the instruction signal 332-D. In some embodiments, the central station 180 is able to control the two-way communication process with DTMF commands for listen, high gain listen, talk, extend mode to keep the two-way communication process active, and disconnect.

The DSP 210 also uses the two-way speakerphone algorithms from the firmware portion 224 to determine whether the digital central station communication signal 338 is feedback from a previously received digital microphone signal 336 sent from the user to the central station 180. If the digital central station communication signal 338 is determined to be feedback from the digital microphone signal 338, the digital central station speech signal 338 is removed. If the digital central station communication signal 338 is not determined to be feedback from the digital microphone signal 336, the digital central station communication signal 338 is sent back to the CODEC 240. The CODEC 240 converts the digital central station communication signal 338 back into the analog central station communication signal 342 and sends the analog central station communication signal 342 to the audio amplifier 116 of the audio module 110-3. The audio amplifier 116 receives the analog central station communication signal 342 and amplifies the analog central station communication signal 342. The audio amplifier then sends the amplified central station communication signal 343 to the speaker 118 which broadcasts the amplified central station communication signal 343 to be heard by the user.

Another communication function of the security system 100 is to provide remote programming of the hardware device modules of the security system 100 using the remote programming tool 195. The remote programming tool 195 is directly coupled to the modem 114 which is indirectly coupled to the telephone interface module 110-4 over a telephone line. The remote programming tool 195 provides remote configuration to the security system 100 whether the remote programming tool 195 is located on the premises being secured or is located remote from the premises being secured. The remote programming tool 195 can be, for example, a personal computer, laptop, cell phone, PDA device or an electronic tool specifically designed for remote programming. Also, in some embodiments, the remote programming tool 195 is used to replace the operating software of the security system 100. FIG. 3E provides a block diagram of a remote programming process according to one embodiment.

When connected, a data message 344 sent from the remote programming tool 195 is received by the telephone interface module 110-4. The data message 344 is then sent by the telephone interface module 110-4 to the CODEC 240. The CODEC 240 receives and decodes the data message 344 into a decoded data message 346. The CODEC 240 then sends the decoded data message 346 to the DSP 210. The DSP 210 accesses firmware portion 224 for remote programming algorithms to process the decoded data message 346 and create a data configuration instruction 348. The DSP 210 then sends the data configuration instruction 348 to the system controller 230. The system controller 230 receives the data configuration instruction 348 and determines whether a configuration of a hardware device module is to be changed. If the system controller 230 determines that a change to the configuration of a hardware device module is necessary, the system controller 230 stores the data configuration instruction 348 into the configuration memory 270, thereby updating the configuration settings of one or more hardware device modules.

The security system 100 can also send data, including a data configuration instruction 348 to the remote programming tool 195. The system controller 230 retrieves the data configuration instruction 348 to be sent to the remote programming tool 195 from the configuration memory 270. The system controller 230 then sends the data configuration instruction 348 to the DSP 210. The DSP 210 receives the data configuration instruction 348 and converts the data configuration instruction 348 into an unencoded data message 352. The DSP 210 then sends the unencoded data message 352 to the CODEC 240. The CODEC 240 encodes the unencoded data message 352 and sends the encoded data message 354 to the telephone interface module 110-4. The telephone interface module 110-4 sends the encoded data message 354 via the modem 114 to the remote programming tool 195.

What is claimed is:

1. A system that provides security communication processes in a security system, the system comprising:
a digital signal processor that implements a plurality of different communication processes;
a memory portion that has a plurality of communication algorithms, each of which implements one or more communication processes within the digital signal processor;
a coder/decoder connected to the digital signal processor to convert analog signals into digital signals prior to being sent to the digital signal processor and to convert digital signals sent from the digital signal processor into analog signals;
wherein the digital signal processor is connected to the memory portion to enable retrieval of at least one communication algorithm for use in implementing the corresponding communication process.

2. The system of claim 1, wherein the coder/decoder and the digital signal processor are not integrated into a single device.

3. The system of claim 1, wherein memory portion is a field-rewritable memory portion.

4. The system of claim 1, wherein the coder/decoder also encodes signals sent from the digital signal processor and decodes signals prior to being sent to the digital signal processor.

5. The system of claim 1, wherein the at least one communication algorithm is at least one event communication algorithm used by the digital signal processor to implement an event communication process.

6. The system of claim 1, wherein the at least one communication algorithm is at least one voice playback algorithm used by the digital signal processor to implement a voice playback process.

7. The system of claim 1, wherein the at least one communication algorithm is at least one phone control algorithm used by the digital signal processor to implement a phone control process.

8. The system of claim 1, wherein the at least one communication algorithm is at least one two-way speakerphone algorithm used by the digital signal processor to implement a two-way speakerphone process.

9. The system of claim 1, wherein the at least one communication algorithm is at least one remote programming algorithm used by the digital signal processor to implement a remote programming process.

10. A method of implementing a security communication process within a security system, the method comprising:
providing a security system comprising a system controller, a memory portion, a coder/decoder and a digital signal processor;
accessing at least one communication algorithm from the memory portion using the digital signal processor;
implementing the security communication process with the digital signal processor using the at least one communication algorithm.

11. The method of claim 10, wherein the security communication process is an event communication process, the at least one communication algorithm is at least one event communication algorithm and implementing the event communication process comprises:
sending an event instruction from the system controller to the digital signal processor;
creating an event communication with the digital signal processor using the at least one event communication algorithm based on the event instruction;
sending the event communication to a central station.

12. The method of claim 11, wherein implementing the event communication process further comprises:
sending an event notification to the digital signal processor;
creating an event response with the digital signal processor using the at least one event communication algorithm based on the event notification;
sending the event response to the system controller.

13. The method of claim 10, wherein the security communication process is a voice playback process, the at least one communication algorithm is at least one voice playback algorithm and implementing the voice playback process comprises:
sending a voice playback instruction from the system controller to the digital signal processor;
retrieving a voice playback recording with the digital signal processor using the at least one voice playback algorithm based on the voice playback instruction;
creating an analog voice playback signal based on the voice playback recording.

14. The method of claim 10, wherein implementing the voice playback process further comprises broadcasting the analog voice playback signal through a speaker.

15. The method of claim 10, wherein the security communication process is a phone control process, the at least one communication algorithm is at least one phone control algorithm and implementing the phone control process comprises:
implementing a voice playback function with the digital signal processor, the voice playback function comprising:
sending a voice playback instruction from the system controller to the digital signal processor;
retrieving a voice playback recording with the digital signal processor based on the voice playback instruction using the at least one voice playback algorithm;
creating an analog voice playback signal based on the voice playback recording; and
sending the analog voice playback signal to a user telephone;
implementing a dual tone multi frequency tone detection function with the digital signal processor, the dual tone multi frequency tone detection function comprising:
sending a digital tone message from a user telephone to the digital signal processor;
creating an instruction signal using the digital signal processor based on the digital tone message;
sending the instruction signal to the system controller.

16. The method of claim 10, wherein the security communication process is a two-way speakerphone process, the at least one communication algorithm is at least one two-way speakerphone algorithm and implementing the two-way speakerphone process comprises:
sending a microphone signal from a user to the digital signal processor;
sending a central station communication signal from a central station to the digital signal processor;
sending the microphone signal to the central station;
broadcasting the central station communication signal over a speaker of the security system.

17. The method of claim 16, wherein implementing the two-way speakerphone process further comprises analyzing the sound level of the microphone signal and the sound level of the central station communication signal to determine whether the microphone signal is sent to the central station or the central station communication signal is broadcasted over the speaker using the at least one two-way speakerphone algorithm.

18. The method of claim 16, wherein implementing the two-way speakerphone process further comprises detecting and removing feedback of the microphone signal and the central station communication signal with the digital signal processor.

19. The method of claim 10, wherein the security communication process is a remote programming process, the at least one communication algorithm is at least one remote programming algorithm and implementing the remote programming process comprises:
sending a data message to the digital signal processor;
creating a configuration instruction with the digital signal processor using the at least one remote programming algorithm based on the data message;
sending the configuration instruction to the system controller.

20. The method of claim 19, wherein implementing the remote programming process further comprises:
sending a data configuration instruction from the system controller to the digital signal processor;
creating an encoded data configuration instruction with the digital signal processor using the at least one remote programming algorithm based on the data configuration instruction;
sending the encoded data configuration instruction to a remote programming tool.
